(19) United States
(12) Patent Application Publication
(10) Pub. No.: US 2025/0347357 A1
(43) Pub. Date: Nov. 13, 2025

(54) SELF-CLOSING DOUBLE-OPENING LOCK

(71) Applicant: Zhejiang chuangge technology co., ltd, Shaoxing (CN)

(72) Inventors: Ning Fang, Shaoxing (CN); Jianfeng Guo, Shaoxing (CN)

(21) Appl. No.: 18/979,523

(22) Filed: Dec. 12, 2024

(30) Foreign Application Priority Data
May 7, 2024 (CN) 202410554053.1

(51) Int. Cl. F16K 35/02

(52) U.S. Cl. CPC F16K 35/022

(57) ABSTRACT

A self-closing double-opening lock comprises a rotating shaft, a reset spring and a hand-opening head, wherein the rotating shaft can be driven by a motor to rotate, one end of the rotating shaft is fixed with a lock head, while the other end is coaxially connected with the hand-opening head after passing through a support seat; the reset spring is sleeved outside the rotating shaft and can realize the reset of the rotating shaft by an elastic force. The rotating shaft which can be driven by the motor to rotate is respectively connected with the hand-opening head and the lock head, and a reset spring is further sleeved outside the rotating shaft; and the reset spring can force the rotating shaft to reset by an elastic force when the motor or the hand-opening head stops driving.

### CROSS-REFERENCE TO RELATED APPLICATION

This application claims priority of Chinese Patent Application No. 202410554053.1, filed on May 7, 2024, the entire contents of which are incorporated herein by reference.

### TECHNICAL FIELD

The present disclosure relates to the technical field of locks, in particular to the technical field of self-closing double-opening locks.

### BACKGROUND

A diesel engine is an engine that burns diesel to obtain energy release, for example a 12-cylinder water-cooled diesel engine disclosed in the invention CN106224094A and a diesel engine disclosed in the invention CN116324141B. Diesel engine has the characteristics of large torque, high thermal efficiency and good economic performance, and is usually used in mobile equipment or transportation (such as trucks, wagons, forklifts, cranes, workover equipment, drilling rigs, excavators, portable generators and welding trucks), emergency vehicles (such as fire engines and ambulances) and small processing devices (such as lawn mowers, blowers, generators, compressors, welding machines and pumps).

Common valves in the market usually include valve plates that can control the cutting and opening of diesel engine pipelines and locking mechanisms (built-in lock heads and lock rods) that can lock the position of the valve plates. Among them, the lock head is usually driven by a motor to rotate and complete the locking or unlocking operation together with the lock rod. However, once the motor fails or the motor is actively or passively powered off (such as power failure), the lock head cannot rotate normally, which makes it difficult for the maintenance personnel to carry out the follow-up maintenance work. In addition, if the lock head is broken directly by hand, there is a certain safety hazard.

### SUMMARY

The present disclosure aims to solve the problems in the prior art, and provides a self-closing double-opening lock, which can realize the electric and manual double-opening of the lock head; meanwhile a reset spring can force the rotating shaft to reset by an elastic force when the motor or hand stops driving. The whole structure is simple, and it is more convenient and safer to use.

In order to achieve the above object, the present disclosure provides a self-closing double-opening lock, which includes a rotating shaft, a reset spring and a hand-opening head; the rotating shaft is drivable by a motor to rotate, one end of the rotating shaft is fixed with a lock head, and the other end of the rotating shaft is coaxially connected with the hand-opening head after passing through a support seat; the reset spring is sleeved outside the rotating shaft and is able to realize the reset of the rotating shaft by an elastic force.

Preferably, the self-closing double-opening lock further includes a coupling head including a coupling plate and a coupling sleeve; the coupling sleeve is integrally provided at a bottom of the coupling plate and a central channel is provided between the coupling sleeve and the coupling plate in a penetrating manner; the coupling sleeve is provided with a plurality of sleeve transverse holes communicated with the central channel respectively, and a top end of the rotating shaft is inserted into the central channel and provided with a plurality of shaft body transverse holes corresponding to respective sleeve transverse holes respectively; the rotating shaft is detachably connected with the coupling sleeve by fasteners passing through the corresponding shaft body transverse holes and the sleeve transverse holes; the hand-opening head is installed on the coupling plate.

Preferably, an edge of the coupling plate extends outward and forms a protruding part with a plate socket, a seat socket is provided on the support seat, and a top end and a bottom end of the reset spring are respectively provided with a top plug and a bottom plug inserted into the plate socket and the seat socket.

Preferably, a top anti-slip sleeve and a bottom anti-slip sleeve are respectively installed outside the top plug and the bottom plug.

Preferably, a sleeve ring groove located below each sleeve transverse hole is provided above the coupling sleeve, and an isolation sleeve is sleeved outside the sleeve ring groove.

Preferably, the coupling plate is provided with a plurality of lower plate through holes provided around the coupling sleeve; the hand-opening head includes a hand-opening plate and a hand-opening sleeve; the hand-opening sleeve is integrally provided on the top of the hand-opening plate and has a hexagonal bump on the top surface thereof, and the hand-opening plate is provided with a plurality of upper plate through holes corresponding to the respective lower plate through holes respectively; the connecting plate is detachably connected with the hand-opening plate by fasteners penetrating the corresponding lower plate through holes and the upper plate through holes.

Preferably, the self-closing double-opening lock further includes a protective cover which is configured to cover the rotating shaft, the coupling head and the reset spring, and is provided with a notch on the top thereof.

Preferably, a top surface of the support seat is further provided with a stepped groove with a big top and a small bottom, and the stepped groove has a shaft sealing ring built in a lower section and a shaft pressing ring built in an upper section; and the shaft sealing ring is confined between the rotating shaft, the shaft pressing ring and the support seat.

Preferably, the top surface of the support seat is provided with a lifting part, and the stepped groove is provided on the lifting part.

Preferably, an outer diameter of the reset spring is smaller than that of the shaft pressing ring, and an inner diameter of the reset spring is larger than that of the shaft pressing ring.

The present disclosure has the following beneficial effects:

1) The rotating shaft which can be driven by the motor to rotate is connected with the hand-opening head and the lock head respectively, and a reset spring is sleeved outside the rotating shaft, thereby the rotating shaft can be driven to rotate electrically by the motor or manually by the hand-opening head, so that the electric and manual double opening of the lock head can be realized; moreover, the reset spring can force the rotating shaft to reset by an elastic force when the motor or the hand-opening head stops driving; the overall structure is simple, and it is more convenient and safe to use.

2) A coupling head fixed by fasteners is installed between the hand-opening head and the rotating shaft, the reset spring is respectively engaged with the coupling head and the support seat through the top plug and the bottom plug located at the top end and the bottom end, which not only ensures the stable connection of all components, but also facilitates the rapid disassembly and maintenance of all components;

3) An isolation sleeve is sleeved on the coupling head, and a shaft sealing ring is installed on the top surface of the support seat, so that the isolation sleeve and the shaft sealing ring can be used to respectively prevent the coupling head and the support seat from being directly worn by the movable reset spring.

4) The top surface of the support seat is provided with a stepped groove with a big top and a small bottom, the shaft sealing ring is built in the lower section of the stepped groove, and the shaft pressing ring is built in the upper section of the stepped groove, so that the sealing performance can be improved by using the shaft sealing ring, and the shaft pressing ring can be matched with the rotating shaft and the support seat to jointly limit the shaft sealing ring.

The features and advantages of the present disclosure will be described in detail by examples with reference to the drawings.

### BRIEF DESCRIPTION OF DRAWINGS

FIG. 1 is an installation schematic diagram of the self-closing double-opening lock of the present disclosure;

FIG. 2 is a front view of FIG. 1 with the lock head, protective cover and gear removed;

FIG. 3 is a sectional view of the self-closing double-opening lock of the present disclosure;

FIG. 4 is a bottom view of the coupling head of the self-closing double-opening lock of the present disclosure;

FIG. 5 is a sectional view taken along the line A-A of FIG. 4;

FIG. 6 is a top view of the hand-opening head of the self-closing double-opening lock of the present disclosure;

FIG. 7 is a sectional view taken along the line B-B of FIG. 6.

Reference signs: 12—Lock head, 2—Self-closing double-opening lock, 21—Rotating shaft, 22—Coupling head, 221—Coupling plate, 2211—Lower plate through hole, 2212—Plate socket, 222—Coupling sleeve, 2221—Sleeve transverse hole, 2222—Sleeve ring groove, 23—Reset spring, 24—Hand-opening head, 241—Hand-opening plate, 2411—Upper plate through hole, 242—Hand-opening sleeve, 2421—Hexagon bump, 25—Isolation sleeve, 26—Protective cover, 27—Shaft sealing ring, 28—Shaft pressing ring, 4—Support seat.

### DESCRIPTION OF EMBODIMENTS

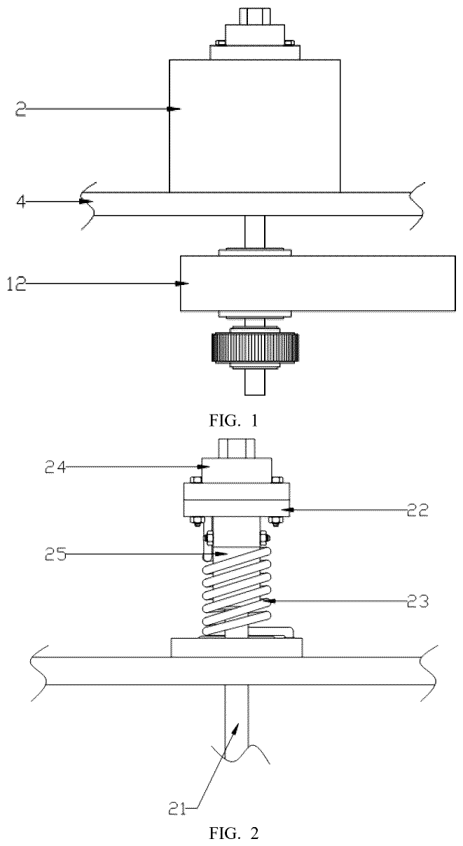

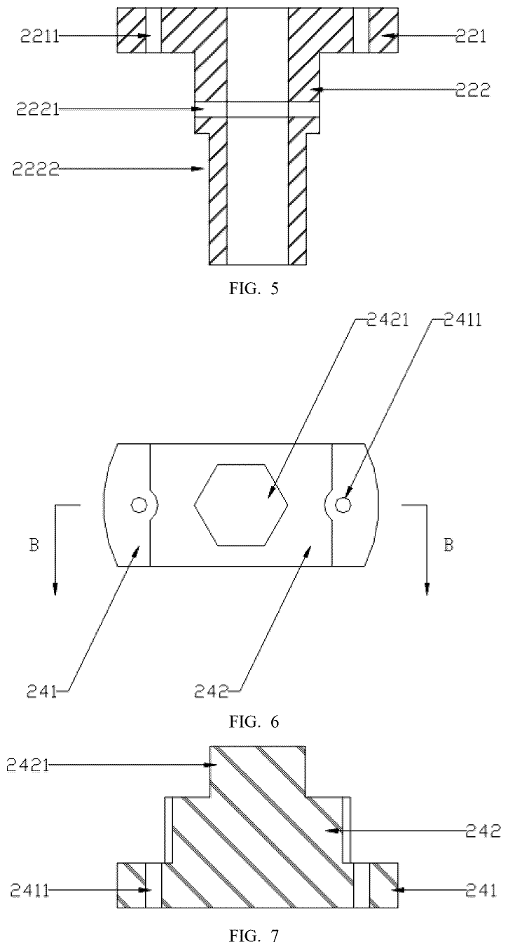

Referring to FIG. 1 to FIG. 7, the self-closing double-opening lock of the present disclosure includes a rotating shaft 21, a reset spring 23 and a hand-opening head 24. The rotating shaft 21 can be driven by a motor to rotate, with one end being fixed with a lock head 12 and the other end being coaxially connected with the hand-opening head 24 after passing through the support seat 4. The reset spring 23 is sleeved outside the rotating shaft 21 and can realize the reset of the rotating shaft 21 by an elastic force.

The self-closing double-opening lock further includes a coupling plate 221 and a coupling sleeve 222, wherein the coupling sleeve 222 is integrally provided at a bottom of the coupling plate 221 and a central channel is provided between the coupling sleeve 222 and the coupling plate 221 in a penetrating manner; the coupling sleeve 222 is provided with a plurality of sleeve transverse holes 2221 communicated with the central channel respectively, and a top end of the rotating shaft 21 is inserted into the central channel and provided with a plurality of shaft body transverse holes corresponding to respective sleeve transverse holes 2221 respectively; the rotating shaft 21 is detachably connected with the coupling sleeve 222 by fasteners passing through the corresponding shaft body transverse holes and the sleeve transverse holes 2221; the hand-opening head 24 is installed on the coupling plate 221.

An edge of the coupling plate 221 extends outward and forms a protruding part with a plate socket 2212, a seat socket is provided on the support seat 4, and a top end and a bottom end of the reset spring 23 are respectively provided with a top plug and a bottom plug inserted into the plate socket 2212 and the seat socket.

A top anti-slip sleeve and a bottom anti-slip sleeve are respectively installed outside the top plug and the bottom plug.

A sleeve ring groove 2222 located below each sleeve transverse hole 2221 is provided above the coupling sleeve 222, and an isolation sleeve 25 is sleeved outside the sleeve ring groove 2222.

The coupling plate 221 is provided with a plurality of lower plate through holes 2211 provided around the coupling sleeve 222; the hand-opening head 24 comprises a hand-opening plate 241 and a hand-opening sleeve 242; the hand-opening sleeve 242 is integrally provided on the top of the hand-opening plate 241 and has a hexagonal bump 2421 on the top surface thereof, and the hand-opening plate 241 is provided with a plurality of upper plate through holes 2411 corresponding to the respective lower plate through holes 2211 respectively; the connecting plate 221 is detachably connected with the hand-opening plate 241 by fasteners penetrating the corresponding lower plate through holes 2211 and the upper plate through holes 2411.

The self-closing double-opening lock further includes a protective cover 26 which is configured to cover the rotating shaft 21, the coupling head 22 and the reset spring 23, and is provided with a notch on the top thereof.

A top surface of the support seat 4 is further provided with a stepped groove with a big top and a small bottom, and the stepped groove has a shaft sealing ring 27 built in a lower section and a shaft pressing ring 28 built in an upper section; and the shaft sealing ring 27 is confined between the rotating shaft 21, the shaft pressing ring 28 and the support seat 4.

The top surface of the support seat 4 is provided with a lifting part, and the stepped groove is provided on the lifting part.

An outer diameter of the reset spring 23 is smaller than that of the shaft pressing ring 28, and an inner diameter of the reset spring 23 is larger than that of the shaft pressing ring 28.

The work process of that disclosure includes the following steps:

Referring to FIG. 1, during operation, the driving force of the motor can be transmitted to the rotating shaft 21 by a transmission mechanism (for example a gear) to drive the lock head 12 to rotate by the rotating shaft 21, so that the lock head 12 can cooperate with the lock rod 11 and complete the locking operation together. When the motor stops working, the reset spring 23 can drive the rotating shaft 21 to rotate by the elastic force, so that the lock head 12 located at the bottom of the rotating shaft 21 can be turned back to the initial position.

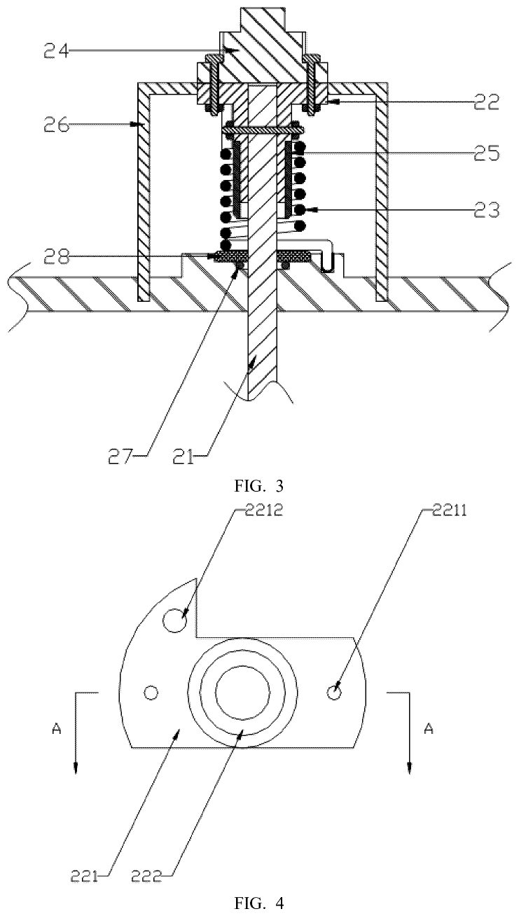

Referring to FIG. 3, when the motor cannot work normally (for example when motor damage or power failure occurs), if the repairman needs to unlock the lock rod 11 and the lock head 12, he may also place a wrench at the hexagonal bump 2421, so as to manually drive the rotating shaft 21 to rotate by screwing the hand knob 24. In addition, if the wrench releases the hexagonal bump 2421, the lock head 12 can also be reset by the reset spring 23 (before the lock rod 11 is locked with the lock head 12).

The above embodiment is an illustration of the present disclosure, rather than a limitation on the present disclosure, and any solution obtained after simple transformation of the present disclosure belongs to the protection scope of the present disclosure.

1. A self-closing double-opening lock, comprising a rotating shaft (21), a reset spring (23) and a hand-opening head (24), wherein the rotating shaft (21) is drivable by a motor to rotate, one end of the rotating shaft is fixed with a lock head (12), and the other end of the rotating shaft is coaxially connected with the hand-opening head (24) after passing through a support seat (4); the reset spring (23) is sleeved outside the rotating shaft (21) and is able to realize the reset of the rotating shaft (21) by an elastic force.

2. The self-closing double-opening lock according to claim, further comprising a coupling head (22) comprising a coupling plate (221) and a coupling sleeve (222), wherein the coupling sleeve (222) is integrally provided at a bottom of the coupling plate (221) and a central channel is provided between the coupling sleeve (222) and the coupling plate (221) in a penetrating manner; the coupling sleeve (222) is provided with a plurality of sleeve transverse holes (2221) communicated with the central channel respectively, and a top end of the rotating shaft (21) is inserted into the central channel and provided with a plurality of shaft body transverse holes corresponding to respective sleeve transverse holes (2221) respectively; the rotating shaft (21) is detachably connected with the coupling sleeve (222) by fasteners passing through the corresponding shaft body transverse holes and the sleeve transverse holes (2221); the hand-opening head (24) is installed on the coupling plate (221).

3. The self-closing double-opening lock according to claim 2, wherein an edge of the coupling plate (221) extends outward and forms a protruding part with a plate socket (2212), a seat socket is provided on the support seat (4), and a top end and a bottom end of the reset spring (23) are respectively provided with a top plug and a bottom plug inserted into the plate socket (2212) and the seat socket.

4. The self-closing double-opening lock according to claim 3, wherein a top anti-slip sleeve and a bottom anti-slip sleeve are respectively installed outside the top plug and the bottom plug.

5. The self-closing double-opening lock according to claim 2, wherein a sleeve ring groove (2222) located below each sleeve transverse hole (2221) is provided above the coupling sleeve (222), and an isolation sleeve (25) is sleeved outside the sleeve ring groove (2222).

6. The self-closing double-opening lock according to claim 2, wherein the coupling plate (221) is provided with a plurality of lower plate through holes (2211) provided around the coupling sleeve (222); the hand-opening head (24) comprises a hand-opening plate (241) and a hand-opening sleeve (242); the hand-opening sleeve (242) is integrally provided on the top of the hand-opening plate (241) and has a hexagonal bump (2421) on the top surface thereof, and the hand-opening plate (241) is provided with a plurality of upper plate through holes (2411) corresponding to the respective lower plate through holes (2211) respectively; the connecting plate (221) is detachably connected with the hand-opening plate (241) by fasteners penetrating the corresponding lower plate through holes (2211) and the upper plate through holes (2411).

7. The self-closing double-opening lock according to claim 2, further comprising a protective cover (26) which is configured to cover the rotating shaft (21), the coupling head (22) and the reset spring (23), and is provided with a notch on the top thereof.

8. The self-closing double-opening lock according to claim 3, further comprising a protective cover (26) which is configured to cover the rotating shaft (21), the coupling head (22) and the reset spring (23), and is provided with a notch on the top thereof.

9. The self-closing double-opening lock according to claim 4, further comprising a protective cover (26) which is configured to cover the rotating shaft (21), the coupling head (22) and the reset spring (23), and is provided with a notch on the top thereof.

10. The self-closing double-opening lock according to claim 5, further comprising a protective cover (26) which is configured to cover the rotating shaft (21), the coupling head (22) and the reset spring (23), and is provided with a notch on the top thereof.

11. The self-closing double-opening lock according to claim 6, further comprising a protective cover (26) which is configured to cover the rotating shaft (21), the coupling head (22) and the reset spring (23), and is provided with a notch on the top thereof.

12. The self-closing double-opening lock according to claim 7, wherein a top surface of the support seat (4) is further provided with a stepped groove with a big top and a small bottom, and the stepped groove has a shaft sealing ring (27) built in a lower section and a shaft pressing ring (28) built in an upper section; and the shaft sealing ring (27) is confined between the rotating shaft (21), the shaft pressing ring (28) and the support seat (4).

13. The self-closing double-opening lock according to claim 8, wherein the top surface of the support seat (4) is provided with a lifting part, and the stepped groove is provided on the lifting part.

14. The self-closing double-opening lock according to claim 8, wherein an outer diameter of the reset spring (23) is smaller than that of the shaft pressing ring (28), and an inner diameter of the reset spring (23) is larger than that of the shaft pressing ring (28).
